(19) United States
(12) Patent Application Publication
(10) Pub. No.: US 2015/0310707 A1
(43) Pub. Date: Oct. 29, 2015

(54) Blackjack Themed Slot Game

(71) Applicant: BEE CAVE GAMES, INC., Austin, TX (US)

(72) Inventor: Nimai Malle, Austin, TX (US)

(73) Assignee: BEE CAVE GAMES, INC., Austin, TX (US)

(21) Appl. No.: 14/262,916

(22) Filed: Apr. 28, 2014

(51) Int. Cl. G07F 17/34; G07F 17/32

(52) U.S. Cl. CPC G07F 17/34; G07F 17/3213

(57) ABSTRACT

A method of entertaining a user includes receiving a user action via a user interface of a computational system; displaying on a display device a first array of card images including at least three positions in a first dimension and at least two positions in a second dimension; displaying on the display device a second array of card images; determining a set of values based on one or more runs including cards from the first array of cards; determining a second array value associated with the second array; comparing each value of the set of values with the second array value; and assigning credits to an account based on the comparing.

### FIELD OF THE DISCLOSURE

This disclosure, in general, relates to themed slot machines and associated games and methods of entertainment.

### BACKGROUND

It was estimated that in 2013 gambling and other games of chance represented a $120 billion industry in the United States. Similarly, the gaming industry represented market sizes of tens of billions in other countries. Such large markets have attracted many game developers, each vying for the attention of consumers in a market overcrowded with gaming options.

Casinos and other gaming establishments use slot machines to attract steady and consistent business. Such games can keep consumers intrigued and entertained for long periods of time, generating significant revenue for the casinos. As such, casinos and gaming establishments have turned to developers in search of new games with which to attract customers. Accordingly, new and innovative games that attract customer attention and retain their interest would be desirable.

### SUMMARY

In an aspect, a standalone machine, a handheld device, or other mobile devices and computers can implement and display a slot-like a game of chance. In response to user input and optionally in accordance with user selected options, a game of chance can be implemented that displays an array of card images used to determine a player's score or scores, displays a set of card images used to determine a dealer score, and credits or debits a players account based on the associated scores or a comparison of player and dealer scores.

### BRIEF DESCRIPTION OF THE DRAWINGS

The present disclosure may be better understood, and its numerous features and advantages made apparent to those skilled in the art by referencing the accompanying drawings.

FIG. 1 and FIG. 2 include illustrations of exemplary gaming platforms.

FIG. 3 includes a block flow diagram illustrating an exemplary gameplay method.

FIG. 4 and FIG. 5 include illustrations of exemplary card arrays.

FIG. 6 includes an illustration of an exemplary score table.

FIG. 7 includes a block flow diagram illustrating an exemplary dealer method.

FIG. 8 includes a block flow diagram illustrating an exemplary win/loss decision method.

FIG. 9 includes an illustration of exemplary payout table.

The use of the same reference symbols in different drawings indicates similar or identical items.

### DETAILED DESCRIPTION

In an exemplary embodiment, a standalone machine, a handheld device, or other mobile devices and computers can implement and display a slot-like a game of chance. In response to user input and optionally in accordance with user selected options, a game of chance can be implemented that displays an array of card images used to determine a player score or scores, displays a set of card images used to determine a dealer score, and credits or debits a players account based on the associated scores or a comparison of player and dealer scores. In a particular example, the game can implement a blackjack-like slot game in which a score associated with the dealer cards can be compared to the score or scores derived from cards within a player card image array. Card images adjacent along lines or runs within the card image array can be selected and tallied to determine a player score, whether the player score exceeds that of the dealer, and whether the player score or the dealer score exceeds a bust value. The players account can be credited or debited in accordance with the payout schedule based on a comparison of the scores of dealer and the player lines or run.

In a particular example, the game can be a single player, multi-hand game of chance, similar to blackjack or 21, that is played against a virtual dealer. Visually, a player can be presented with images of standard playing cards with card values being worth their illustrated value, face cards such as Jack, Queen, or King being worth 10 points, and an Ace being worth either 1 or 11 points. The goal of the game can be to obtain a player hand with a value greater than the dealer value without going over a bust value, for example 21. The dealer hand can be dealt two initial cards. The dealer continues to receive cards until a sum of the cards is equal to or exceeds at least a dealer stay value. In an example, the dealer stay value can be 15, 16, 17, or 18. In particular, the dealer stay value can be 17.

Player cards are illustrated in an array, grid, or matrix. Player hands form following lines, pathways, or runs starting from one side of the array and extending toward the other side of the array. Lines, pathways or runs are unique sequences of card images formed by different patterns for selecting the card images, starting from one side of the array and extending toward another side of the array. Each of the player hands includes only cards hands sequentially along a pathway, line or run until the value of the hand (e.g., the sum of cards) reaches or exceeds the player stay value or a set number of cards is used. In an example, the player stay value can be 15, 16, 17 or 18. In particular, the player stay value may be 17. The number of card images in a run or line can be limited by the width of the array. As such, an individual hand may use less than the total number of cards extending across the array in the direction along the line or pathways used to select cards for adding to the hand.

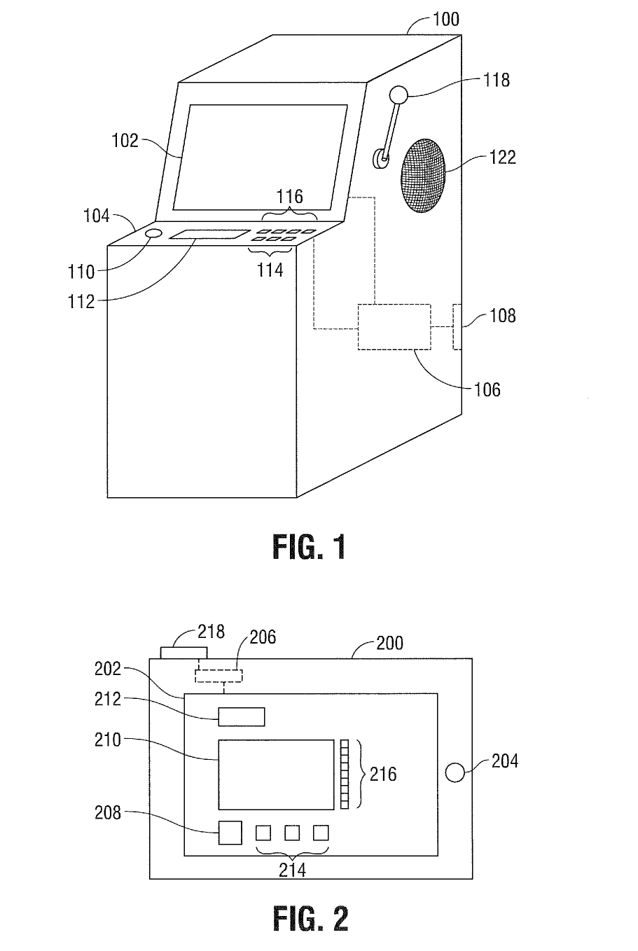

In particular, the blackjack-like slot game can be implemented as a standalone device, a portable device, or on other computational circuitry, such as a personal computer or gaming console. For example, as illustrated in FIG. 1, a gaming device 100 can be configured as a standalone machine including one or more displays 102 and a user interface 104. The device 100 can include a computational circuitry 106 in communication with the one or more displays 102, the user interface controls 104, one or more sound devices 122, and optional communication circuitry 108. The computational circuitry 106 can receive inputs from the user interface 104, display aspects of the game on the one or more displays 102, and alert or reward a user with sound using the speakers 122 or using the display 102 to display images, video, or additional games.

Further, the computational circuitry 106 can communicate using the communications interface 108 with an external system, such as a remote server. For example, the network interface 108 can provide network communications to remote systems for implementing software updates or repairs, altering aspects of the gameplay, communicating aspects of the gameplay, providing user information, such as credits and debits from user account, or communicating operating parameters, or any combination thereof.

The user interface 104 can include buttons, touchscreen or touch sensitive displays, levers, pointing devices such as a rollerball, joystick, or a mouse like device, or any combination thereof. In a particular example, the user interface 104 includes a spin button 110. In addition or alternatively, the user interface 104 can include a lever arm 118. In a further example, the user interface 104 includes a touch device 112, buttons 114, or additional selectors 116. For example, the user interface 104 can include a touchscreen 112 or a set of buttons 114 for selecting a number of lines or an amount to bet. In addition, the user interface 104 can include a set of buttons or selectors 116 for selecting options associated with the gameplay. In a further example, the one or more displays 102 can include touchscreen displays.

In another example illustrated in FIG. 2, a portable device 200 can include a touch sensitive display 202. Optionally, the touch sensitive display 202 can also include one or more physical buttons 204 and a network interface 218. A computational circuitry 206 can be in communication with the touch sensitive display 202, the one or more physical buttons 204, the network interface 218, or a combination thereof. In a particular example, during gameplay, the display 202 can display an array of cards 210 associated with the player and from which the player scores are determined. The display 202 can also display a set of cards 212 associated with the dealer hand and from which the dealer score is determined. The display 202 can also display a spin button 208 and a set of buttons 214 for selecting a bet amount or a number of lines. Additional options can also be provided using buttons of the buttons 214. The display 202 can further display scores 216 associated with each line extending through the array 210 of player card images. Further, the display 202 can display aesthetic features to enhance the attractiveness of gameplay.

Similar displays and interfaces can be implemented on computational devices including portable devices, such as tablet devices, laptops, or smart phones, or standalone personal computers or gaming consoles, or any combination thereof. Alternatively, the game can be implemented as a physical card game, played by dealing cards and scored as described above in relation to an electronic game. In a further example, the displays and interfaces can be incorporated into social media platforms.

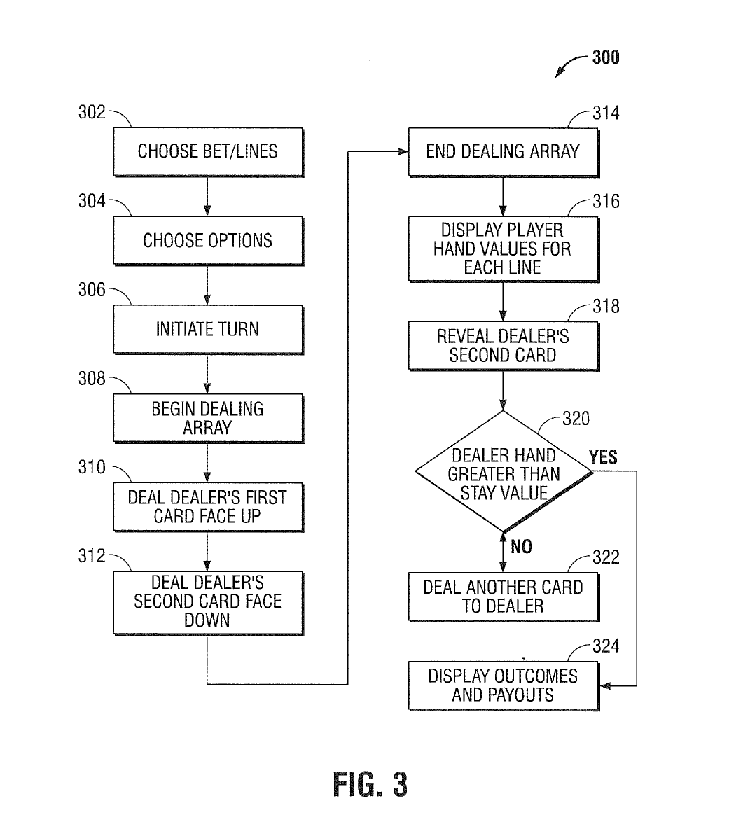

FIG. 3 illustrates an exemplary method 300 for implementing the gameplay of a blackjack-like slots game. For example, as illustrated at 302, a player can choose a bet or wager amount or a number of lines. For example, a total bet or an amount per line can be designated by a player or a player can select a number of lines. Alternatively, the number of lines can be set and a user can determine how much to bet per line. In further example, a user can select a total bet or wager amount and a number of lines. Optionally, as illustrated at 304, the player can select gameplay options, such as variations on rules associated with the game or an option to prevent one or more lines from exceeding a bust value, such as 21 in a blackjack-like game, referred to as a no-bust line. Such options can be provided for free or can incur additional charges or wagers. Exemplary variations and rules include a selection of a player stay value, a dealer stay value, a no bust line, splitting, doubling down, a soft stay option, or any combination thereof. Splitting can include splitting a hand into two hands and adding optionally adding a wager amount to the second hand. Such splitting may be implemented when consecutive Aces are shown as the first two cards in a hand. In a particular example, the first of the split hands may receive the next card in a run while the second hand of the split hands may receive the card following the next card in a run. A doubling down option may, for example, double the wager for a given line when a particular pattern of cards is shown.

Once the player selects a bet or a number of lines, the user can initiate a turn, for example, by pressing a spin button or pulling a lever, as illustrated at 306. In particular, the game can be configured to initiate a turn in response to pressing a button, the use of a rollerball, pulling a lever, or gesturing on a touch sensitive display, or any combination thereof.

As part of the game, an array of player cards is displayed. The array of player cards can be generated in a variety of manners, for example, the visually presentation of dealing cards from a shuffled shoe containing one or more standard 52 card decks. In another example, the player card array can be populated using virtual slot machine style reels, where each real contains symbols from a standard 52 card deck. Optionally, the deck can include wild cards or Jokers. In particular, the array of cards can be presented using spinning wheels of card symbols, much like a video slot machine; animating the cards one by one as if they are being dealt; dropping in one by one as tiles; fading in; or other equivalent visual presentations of the cards.

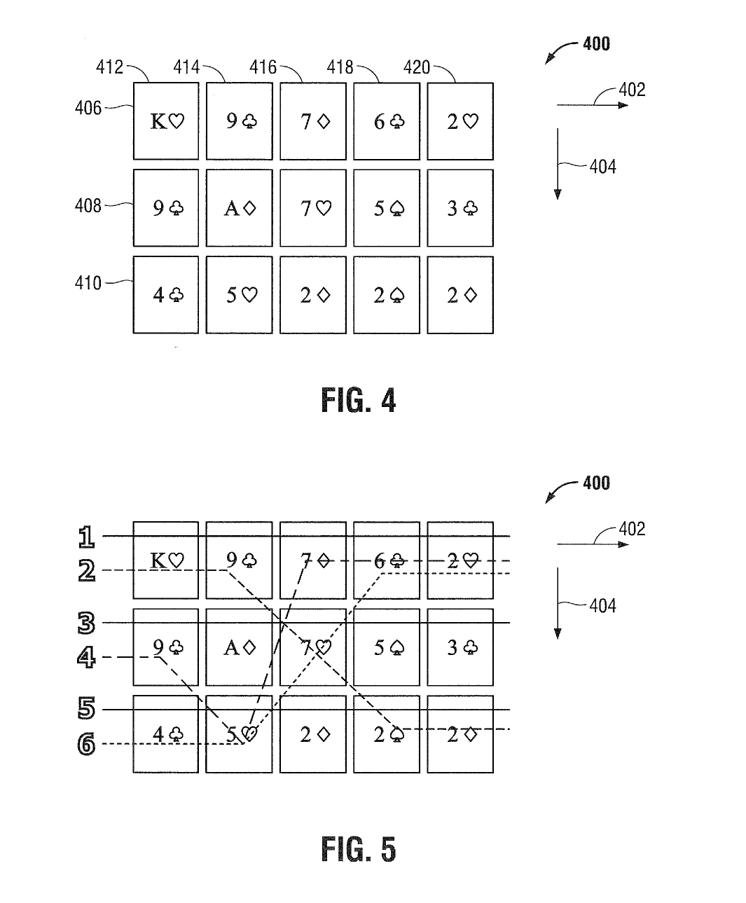

Optionally, the display shows spinning wheels illustrating cards of a card deck that align to form an array of cards, as illustrated at 308. Alternatively, the cards can be illustrated as being placed in the array as if being dealt. FIG. 4 includes an illustration of an exemplary array. In an example, the spinning motion can move downward through the array. Alternatively, the spinning motion can be upward through the array. In another example, the spinning motion can move side can move from one side to another side, along a row of the array.

As illustrated at 310, a dealer first card can be displayed face up. The dealer second card can be displayed face down, as illustrated at 312. The dealer first and second cards can be displayed while the wheels of the player card array are spinning. Once the dealer cards are displayed, the wheels can be stopped, as illustrated at 314. Alternatively, the wheels can stop spinning prior to the dealers cards being dealt, between dealing cards, or after the cards are dealt.

The card images on display can be selected from cards associated with a standard deck, including cards of 4 suits and 13 cards per suit (i.e., A, 2-10, J, K, Q). The deck can further include one or more Jokers, one or more wild cards, one or more other symbols, or any combination thereof. Such Jokers, wild cards, and other symbols can be used to implement other game features.

The likelihood or probability of a card being placed in a slot or position within the player array can be based on the probability of selecting a card from a virtual shoe that mimics a standard deck. The probability distribution indicative of a likelihood or probability of a select card being selected is referred to as the card distribution. In another example, the likelihood can be based on the use of a virtual shoe that mimics multiple shuffled decks. In a particular example, each game can be drawn from a virtual shoe including multiple virtual decks, such as between six and eight decks. As cards are selected to show for each gameplay, the system may display a card count, for example, the number of cards of value 10 that have been dealt. Periodically, the virtual shoe can be reshuffled. Alternatively, the probability of a card being dealt (e.g., the card distribution) can be customized and may not follow a standard deck. Settings associated with the virtual shoe can be modifiable. For example, a player may be provided options associated with the virtual shoe, such a number of decks, frequency of shuffling, or a combination thereof.

Depending upon the options selected by the user and the number of lines to be played by the player, the values or scores for each active line through the card array can be calculated and displayed, as illustrated at 316. In a particular example, the score is updated as each card in the array is newly displayed. In an example, an array includes three rows (406, 408, and 410 of FIG. 4) and five columns (412, 414, 416, 418, and 420 of FIG. 4), a selection of one line or run can correspond with a hand using a middle row (e.g., 408). In another example, a selection of three lines or runs can result in hands scored along the three rows (e.g., 406, 408, or 410). In further examples, runs may be selected such that score values can be calculated from lines extending across rows between adjacent columns. FIG. 5 illustrates exemplary lines extending through an array. In an example, a score or value of a line or run can be determined starting with the leftmost card along the line and moving to adjacent cards in the line. The score or run value can be determined by adding adjacent cards along the run until the sum of the added cards equals or exceeds a player stay value, for example, 17.

Once the player scores are determined and optionally displayed, a dealers hand can be determined. For example, the second card of the dealers hand can be revealed, as illustrated 318. The game can determine whether the dealer hand equals or exceeds a dealer stay value, for example 17, as illustrated 320. When the dealer hand is not equal to or has not exceeded the dealer stay value, the dealer hand can be provided with another card, as illustrated at 322, and the dealer hand value can be calculated again. Alternatively, the player hands and the dealer hand can be displayed in any order or concurrently.

Once the dealer hand equals or exceeds the dealer stay value, e.g., 17, the outcome and payouts for each player hand can be displayed, as illustrated at 324. For example, when a score of a player hand along an active line or run exceeds the dealers hand without exceeded a bust value, the player can be credited or rewarded in accordance with the gameplay. In another example, when the dealer hand exceeds a bust value, player hands that do not can be credited. When a player hand is equal to a blackjack value, e.g., 21, and the dealer hand is not, the player hand can be designated a winning hand. When the value of a dealer hand exceeds the value of a player hand, the player account can be debited. Optionally, when a player hand and the dealer hand are tied, the player account can be debited, credited, or held until a subsequent gameplay. The player account can have an associated monetary value. Alternatively, the player account can represent points having no monetary value. The points may be purely for entertainment and optionally, can be compared to points of other players within a social group or network or on a social medial platform. In a further example, points can be redeemable for prizes, services, or a combination thereof.

In addition to determining a score, the game can seek additional patterns or features of a line or run of cards extending through the array of cards. For example, the game can seek three cards in a row having the same value, such as three 7s. When wildcards are included as part of the game, a row including two, three or more wildcards can elicit a further award. Exemplary patterns include cards of the same suit, cards of the same numerical value, cards having unique characteristics, such as a wildcard, a suicide King, the Queen of spades, or a one eyed Jack, or cards having consecutive increasing values. The player may be awarded based on the pattern discovered, for example, independent of the run value or a dealer value. Alternatively, the player may be awarded based on the pattern when the run value does not exceed a bust value. Such awards can include visual stimulation, auditory awards, a video sequence, or credits or non-credit points, a free spin, or a combination thereof. In a further example, the player can be provided with a secondary game different from the blackjack-themed slot game in response to the discovered pattern or exceeding a number of non-credit points. Exemplary secondary games can include arcade games, variations on poker, blackjack, checkers, among others, or a combination thereof.

In an example, a grid, array, or matrix of player cards can be displayed, generally referred to as the array of cards. Locations of cards or card images within the array are card positions. As illustrated in FIG. 4, the array of cards or card images 400 can extend a first number of cards in a first dimension 402 and a second number of cards in a second dimension 404. In the illustrated example, the first dimension 402 includes rows and the second dimension includes columns 404. Alternatively, the first dimension can include columns and second dimension can include rows. The array 400 is illustrated as including three rows 406, 408 and 410 extending along the first dimension 402 and including five columns 412, 414, 416, 418, and 420 extending along the a second dimension 404. In particular, the array of player cards can include at least three card positions in the first dimension and at least two card positions in the second dimension. An exemplary array of dealer cards can include at least two card positions in the first dimension and at least one card position in the second dimension, such as a single card position in the second dimension.

Cards within the array of cards 400 are considered adjacent in the first dimension when, for example, the cards are disposed in adjacent columns, regardless of their position within the column. Cards within the array of cards 400 are in the same position along the second dimension when, for example, the cards are disposed in the same row and are in different positions along the second dimension when, for example, the cards are disposed in different rows. For example, a card at row 406 and column 412 is adjacent within the first dimension to a card at row 406 and column 414 or is adjacent within the first dimension to a card at row 410 and column 414. The card at row 406 and column 412 is in the same position along the second dimension as the card at row 406 and column 414, whereas the card at row 406 and column 412 is at a different position along the second dimension as the card at row 410 and column 414.

Visually, the array 400 can be formed by a display of spinning wheels in which the cards traverse along columns moving down through the second dimension 404. Alternatively, the spinning wheels can move up through the columns along the second dimension 404. In a further alternative, the cards can move in a simulated spinning motion along rows in the first dimension 402, either spinning from left to right or right to left. In another example, the cards can be presented as being dealt into the array 400, be presented as being flipped, or other static or dynamic presentations of providing the array 400 of cards, or any combination thereof.

While the array 400 is illustrated as including three rows and five columns, the array 400 can include between 2 and 10 rows, such as between 2 and 6 rows or between 2 and 5 rows. Further, the array can include between 3 and 10 columns, such as between 3 and 6 columns or between 4 and 6 columns.

The player hand or hands are formed by following lines extending through the array of cards 400. Exemplary lines or runs through the cards can extend in a direction along the first dimension, for example through adjacent columns. Some exemplary runs extend along a single row. Other exemplary runs or lines extend through adjacent columns but switch rows. For example, FIG. 5 illustrates exemplary runs or lines 1, 2, 3, 4, 5, and 6, extending through the array 400, generally in a direction along the first dimension 402. As illustrated, scores or values can be calculated by selecting cards starting at the left of the array 400 and following the pathway or line to the right through adjacent columns, selecting cards from the same or different rows within adjacent columns. For example, each of lines 1, 3, and 5 extends through a single row and includes cards from each column. In another example, lines, such as 2 and 6, include two cards within a row selected from columns 412 and 414, a third card selected from a middle row and column 416, and fourth and fifth cards selected from a different row at columns 418 and 420. In another example, the line or run 4 includes a card from the middle row 408 and column 412, a second card from row 410 and column 414, a third card, fourth card, and fifth card selected from row 406 and columns 416, 418, and 420. Depending upon the array dimensions, the style of play, and other options, additional runs can be envisaged to extend through the array of cards.

In an example, lines 1, 3, and 5 extend within a single row and include a card in the first position of the first dimension and include adjacent cards along the first dimension within the same position along the second dimension. In another example, line 2, line 4, and line 6 include a card in the first position of the first dimension and include at least two cards adjacent along the first dimension and in different positions along the second dimension. In particular, line 2, line 4, and line 6 include cards from each position of the second dimension.

As illustrated, the player scores are determined by selecting cards along a run starting from the left and continuing towards the right. Alternatively, cards can be selected starting from the right and continuing to the left along the first dimension 402. In a different example in which the array first dimension extends along columns and a second dimension extends along rows, the cards can be selected starting at the top and continuing towards the bottom or selected from the bottom and continuing towards the top along a pathway or line.

To determine player scores, depending upon the number of lines selected, cards adjacent in the first dimension 402 are added to a total for the line or run. Once the sum reaches or exceeds a player stay value, for example 17, no additional cards are added to the sum. As such, not all cards within the array or along a particular line or run are used for each player hand. The system may provide the player with the option to modify the stay value. For example, the stay value may be selectable by the player. Such an option may be provided prior to a spin and may incur additional cost to the player.

In an example, cards are treated as having a numerical value associated with the display value of the card, face cards such as Jacks, Kings, or Queens can be treated as 10, and Aces can have a value of 1 or 11. Wildcards can have a variable value or no value. In an example, the variable value of the wild card can be selected to provide a score of blackjack for a run in which the wild card is used. In a particular example, the goal of the game is to acquire a hand having a high value without exceeding 21. Player hands are compared to the dealer hand, and player hands that exceed the dealers hand without exceeding a bust value (e.g., 21) are designated as winning hands, while others are designated as tie or losing hands.

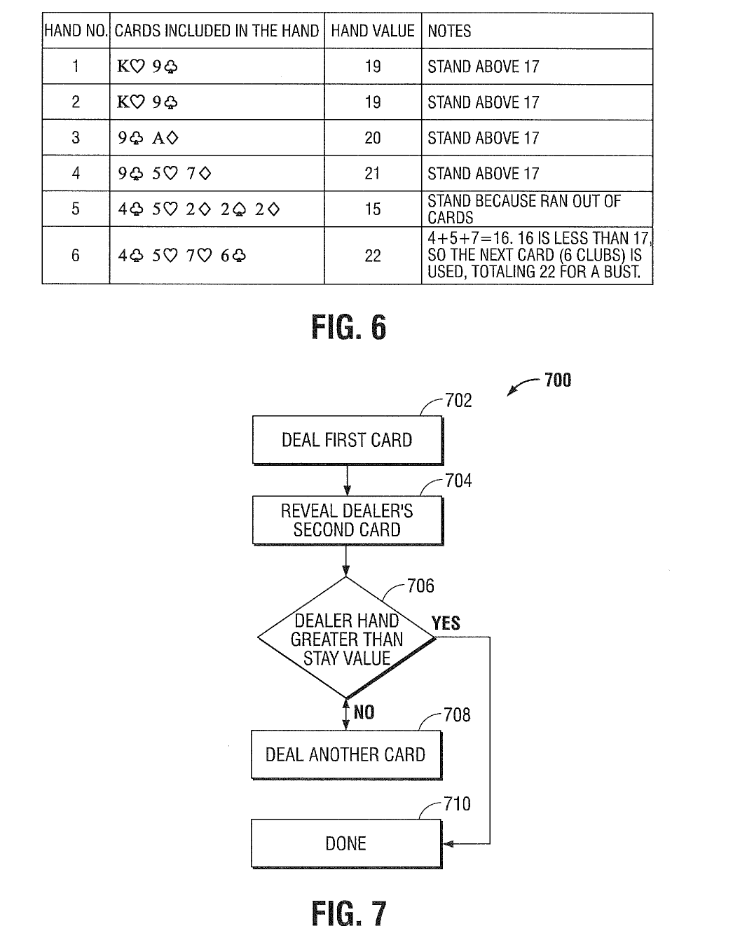

In an example in which the player stay value is 17, the exemplary array 400 illustrated in FIG. 4 and FIG. 5 can result in values illustrated in FIG. 6. For example, following the first run or line 1 and extending through the array 400, a King and nine are selected for a score of 19. The score of 19 exceeds 17 (e.g., the player stay value), and thus, the subsequent or adjacent card having a value seven is not added to the value of the player hand. Similarly, the line 2 selects the first two cards from the first row 406, providing a sum of 19. As such, the next card extending within the line 2. i.e., a 7 selected from row 408 and column 416, is not added to the sum of the player hand extending along the line 2. In another example, line 3 selects a 9 and ace from row 408, which provides 20, assuming the ace has a value of 11. In a further example, line 4 selects a 9 from row 408 and a 5 from row 410, which provided a sum of 14. Because the sum does not exceed the player stay value, e.g., 17, the value of the adjacent card within the line 4 (i.e., 7 of row 406 and column 416) is added to the sum. The resulting value is 21, which exceeds the player stay value 17 and does not exceed the bust value of 21. In further example, line or run 5 extends through row 410, selecting cards 4, 5, 2, 2, and 2. Because the sum of the card values does not exceed 17, each of the values within the row or extending along the run 5 through the array 400 is added to the player hand, providing a score of 15. Optionally, the run can be designated a winning player hand independent of dealer score, because the run included each of the cards across the width of the array. In the example of line 6, the card values of 4, 5, 7, and 6 are selected providing a score or value of 22, which exceeds a bust value, e.g., 21. The score is not determined using the 4, 5, and 7 alone, because the sum of 16 does not exceed the player stay value of 17. However, when the player stay value is set to 16 or when a no-bust line option is provided to the player, the value of 16 may be used.

As illustrated in FIG. 7, a method 700 of providing a dealer hand includes dealing two cards, as illustrated at 702 and 704. Aesthetically, the dealing of the cards can appear like the cards are dealt by a dealer. Alternatively, the cards can be dealt as if displayed on a roller or wheel. In another example, the cards can appear and can be flipped during gameplay. The dealing of cards can be performed prior to displaying the array of player cards, while the array of player cards is forming, or after the array of player cards has formed. In particular, a first dealer card can be dealt face up and a second dealer card can be dealt face down. Once the player hands are displayed, for example, using the card array and the associated lines or runs extending through the card array, the second card of the dealer hand can be flipped or displayed.

As illustrated at 706, the value of the hand, including the first two cards, can be determined. When the value is less than a dealer stay value, such as 17, an additional card can be dealt, as illustrated at 708. As long as the value of the hand is less than the dealer stay value or a maximum number of cards are dealt, additional cards can be dealt. Optionally, there is no maximum number of cards. Once the value equals or exceeds the dealer stay value, the dealers hand is complete, as illustrated at 710. While the dealer hand may not use a grid, matrix, or array of cards as used in conjunction with the player hand, the dealer hand can be displayed separately and may have no limit on card length. In contrast, the number of cards in a player hand can be limited by the width of the array of cards.

Alternatively, adding adjacent cards to the player hand can stop based on a soft player stay value. In an example, adding adjacent cards may continue until the player stay value (e.g., 17) is hit unless one of the cards can have more than one value, for example, an Ace, which can take on the value of 1 or 11. For example, a hand that includes Ace+6 can be considered 17 or can be considered 7. Under a soft player stay value, additional adjacent cards can be added to the Ace+6 in an attempt to achieve a better score. Similarly, a soft dealer stay value can be applied, having similar treatment of the Ace.

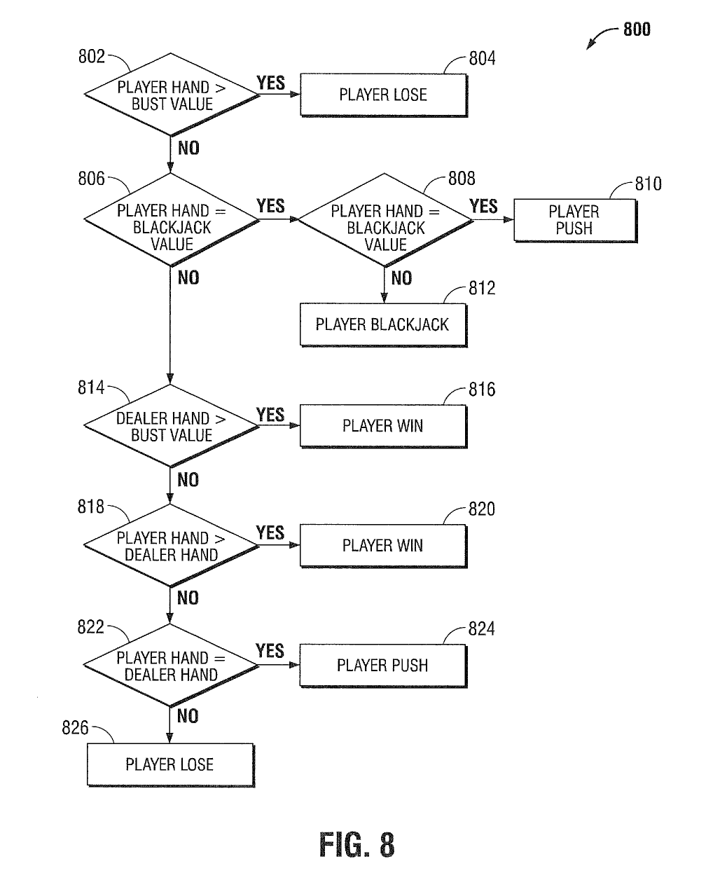

Following the determination of the player hand values and the dealer hand value, each player hand is compared against the dealer hand to determine an outcome. In an example, the possible outcomes for each player hand include a win, a loss, a push, or blackjack. For example, as illustrated in FIG. 8, a method 800 includes determining whether a player hand exceeds a bust value, e.g., 21, as illustrated at 802. When the player hand exceeds the bust value, the player loses, as illustrated at 804, referred to as bust. When the player hand does not exceed the bust value, the system can determine whether the player hand has achieved blackjack, as illustrated 806, for example having a score 21.

When the player hand as a value of blackjack (e.g., 21), the system can determine whether the dealer hand is blackjack, as illustrated at 808. When the dealer hand has blackjack, the outcome can be a push, as illustrated 810. In an example, the players bet may be retained for subsequent game. In another example, a player's wager can be returned or credited, or the player can be provided with a free spin. When the dealers hand does not blackjack, the player is awarded blackjack, as illustrated at 812.

When the player hand is not blackjack, the system can determine whether the dealer hand has exceeded a bust value, as illustrated 814. When the dealers hand has exceeded the bust value and the players hand has not exceeded the bust value, the player wins, as illustrated at 816.

When the dealer hand does not exceed a bust value, the system can determine whether the player hand is greater than the dealer hand, as illustrated at 818. When the player hand is greater than the dealer hand, the player wins, as illustrated 820.

When the player hand does not exceed the dealer hand, the system can determine whether the player hand equals the dealer hand, as illustrated 822. When the player hand equals the dealer hand, the player may be awarded a push, as illustrated 824. In the event that the player hand is less than the dealer hand, the player loses, as illustrated 826.

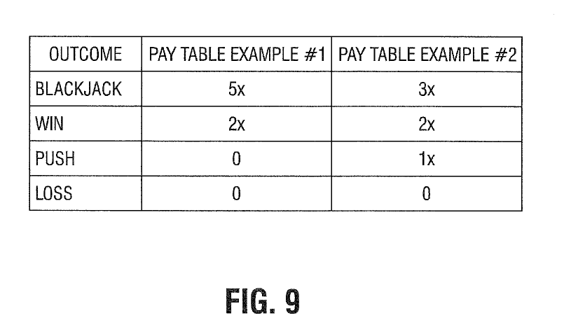

The amount returned to the player in exchange for a wager can be determined by a payout table. For example, FIG. 9 illustrates an exemplary payout table. The amount can vary depending upon the outcome of the comparison of each of the player hands with the dealer hand. In one example, the pay table can pay a multiple of the wager when blackjack is achieved, such as for example five times the wager. The game can pay at different multiple of the wager when a win is achieved, for example, two times the wager. In the first example, a player does not receive credit in a push or in a loss. In a second example, the player can be paid a lower multiple when obtaining a blackjack, the same two times multiple in response to win, but can be refunded or credited the wager in response to a push.

In a first aspect, a method of entertaining a user includes receiving a user action via a user interface of a computational system; in response to receiving the user action, displaying on a display device a first array of card images including at least three positions in a first dimension and at least two positions in a second dimension; displaying on the display device a second array of card images including at least two positions in the first dimension and at least one position in the second dimension; determining a set of values based on one or more runs including card images from the first array of card images, at least one run of the one or more runs including a first position of the first dimension with at least two card images adjacent in the first dimension and in different positions in the second dimension; determining a second array value associated with the second array; comparing each value of the set of values with the second array value; and assigning credits to an account based on the comparing.

In an example of the first aspect, the method further includes displaying the set of values.

In another example of the first aspect and the above examples, card images assigned to each position within the first array of card images are selected based on a card distribution.

In a further example of the first aspect and the above examples, a second run includes a card image in the first position of the first dimension and at least two card images adjacent in the first dimension and in the same position along the second dimension.

In an additional example of the first aspect and the above examples, a second run includes a card image in the first position of the first dimension and at least three card images in different positions in the second dimension.

In another example of the first aspect and the above examples, the at least one run includes card images from all positions within the first dimension. For example, the method can further include assigning a win to the at least one run independent of the second array value when a run value of the at least one run does not exceed a bust value.

In a further example of the first aspect and the above examples, the method further includes assigning an award based on a pattern of card images within the at least one run independent of a run value. For example, the award can include additional game play, credit points, non-credit points, a secondary game, a video sequence, or any combination thereof.

In an additional example of the first aspect and the above examples, the method further includes changing a run value to a previous run value when the run value exceeds a bust value. For example, the method can further include receiving a no-bust line selection via the user interface.

In another example of the first aspect and the above examples, the method further includes receiving a split rule selection via the user interface.

In a further example of the first aspect and the above examples, the method further includes receiving a soft stay value selection via the user interface.

In an additional example of the first aspect and the above examples, the method further includes receiving a player stay value via the user interface.

In another example of the first aspect and the above examples, the method further includes displaying a card count associated with cards previously provided in the first array of card images or the second array of card images.

In a further example of the first aspect and the above examples, the method further includes receiving a wager amount via the user interface.

In an additional example of the first aspect and the above examples, the method further includes receiving a number of runs via the user interface.

In a second aspect, a method of entertaining a user includes assigning a card selected from a set of cards to each player position within a player card array, the player card array including at least three positions in a first dimension and at least two positions in a second dimension; determining a run value of a run including a first position of the first dimension with at least two cards adjacent in the first dimension and in different positions in the second dimension of the player card array, the run value based on a sum of values of the at least two cards, the number of cards in the sum selected so that the sum exceeds a player stay value; assigning a card selected from the set of cards to each dealer position within a dealer card array, the dealer card array including at least three positions in the first dimension and a single position in the second dimension; determining a dealer value based on a sum of values of at least two cards, the number of cards in the sum selected so that the sum exceeds a dealer stay value; comparing the run value with the dealer value; and assigning a credit based on the comparing.

In an example of the second aspect, the set of cards is a deck of cards.

In another example of the second aspect and the above examples, the card assigned to the each player position within the player card array is selected based on a card distribution.

In a further example of the second aspect and the above examples, the method further includes determining a second run value of a second run including a card in the first position of the first dimension and at least two cards adjacent in the first dimension and in the same position along the second dimension.

In an additional example of the second aspect and the above examples, the method further includes determining a second run value of a second run including a card in the first position of the first dimension and at least three cards in different positions in the second dimension.

In another example of the second aspect and the above examples, the run includes cards from all positions within the first dimension. For example, the method can further include assigning a win to the run independent of the dealer value when the run value does not exceed a bust value.

In a further example of the second aspect and the above examples, the method further includes assigning an award based on pattern within a run independent of the run value. For example, the award can include additional game play, credit points, non-credit points, a secondary game, a video sequence, or any combination thereof.

In an additional example of the second aspect and the above examples, the method further includes changing the run value to a previous value when the run value exceeds a bust value. For example, the method can further include receiving a no-bust line selection from the user.

In another example of the second aspect and the above examples, the method can further include receiving a split rule selection from the user.

In a further example of the second aspect and the above examples, the method can further include receiving a soft stay value selection from the user.

In an additional example of the second aspect and the above examples, the method further includes receiving a player stay value from the user.

In another example of the second aspect and the above examples, assigning credit includes assigning credit based on pay-out schedule.

In a further example of the second aspect and the above examples, the method further includes displaying a card count associated with cards previously provided in the player card array or the dealer hand.

In an additional example of the second aspect and the above examples, the method further includes receiving a wager amount from the user.

In another example of the second aspect and the above examples, the method further includes receiving a number of runs from the user.

In a further example of the second aspect and the above examples, the set of cards includes a wild card. For example, the wild card can have a value sufficient to yield a run value of blackjack. In another example, the method further includes awarding a player hand that includes a set of wild cards.

In a third aspect, a system includes a user interface; a display device; and a computational circuitry in communication with the user interface and the display device. The computational circuitry is to implement a method including receiving a user action via the user interface; in response to receiving the user action, displaying on the display device a first array of card images including at least three positions in a first dimension and a single position in a second dimension; displaying on the display device a second array of card images including at least two positions in the first dimension and at least one position in the second dimension; determining a set of values based on one or more runs including card images from the first array of card images, at least one run of the one or more runs including a first position of the first dimension with at least two card images adjacent in the first dimension and in different positions in the second dimension; determining a second array value associated with the second array; comparing each value of the set of values with the second array value; and assigning credits to an account based on the comparing.

In an example of the third aspect, the system further includes a network interface in communication with the computational circuitry, the computational circuitry to communication with a remote server via the network interface.

In a fourth aspect, a system includes a user interface; a display device; and a computational circuitry in communication with the user interface and the display device. The computational circuitry is to implement a method of any one of the first or second aspects above or their associated examples and combinations thereof.

In an example of the fourth aspect, the system further includes a network interface in communication with the computational circuitry, the computational circuitry to communication with a remote server via the network interface.

While the embodiments described above are characteristic of a blackjack or 21 style game, other similar games, such as baccarat, can be implemented using the above-described systems and methods.

Aspects of the above-described system and games can be implemented using computational circuitry programmed with instructions to implement features of the game. Such instructions can be stored in non-transitory storage accessible by the computational circuitry. In other examples, such instructions can be stored in non-transitory storage, such as optical storage (e.g., CDs or DVDs), magnetic storage (e.g., hard disc drives), electronic storage (e.g., ROM, RAM, or other solid-state storage), or any combination thereof. The computational circuitry can include one or more processors operable in accordance with the program instructions to implement aspects of the games.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes.” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

What is claimed is:

1. A method of entertaining a user, the method comprising:
receiving a user action via a user interface of a computational system;
in response to receiving the user action, displaying on a display device a first array of card images including at least three positions in a first dimension and at least two positions in a second dimension;
displaying on the display device a second array of card images including at least two positions in the first dimension and at least one position in the second dimension;
determining a set of values based on one or more runs including card images from the first array of card images, at least one run of the one or more runs including a first position of the first dimension with at least two card images adjacent in the first dimension and in different positions in the second dimension;
determining a second array value associated with the second array;
comparing each value of the set of values with the second array value; and
assigning credits to an account based on the comparing.

2. The method of claim 1, further comprising displaying the set of values.

3. The method of claim 1, wherein card images assigned to each position within the first array of card images are selected based on a card distribution.

4. The method of claim 1, wherein a second run includes a card image in the first position of the first dimension and at least two card images adjacent in the first dimension and in the same position along the second dimension.

5. The method of claim 1, wherein a second run includes a card image in the first position of the first dimension and at least three card images in different positions in the second dimension.

6. The method of claim 1, wherein the at least one run includes card images from all positions within the first dimension.

7. The method of claim 6, further comprising assigning a win to the at least one run independent of the second array value when a run value of the at least one run does not exceed a bust value.

8. The method of claim 1, further comprising assigning an award based on a pattern of card images within the at least one run independent of a run value.

9. The method of claim 8, wherein the award includes additional game play, credit points, non-credit points, a secondary game, a video sequence, or any combination thereof.

10. The method of claim 1, further comprising changing a run value to a previous run value when the run value exceeds a bust value.

11. The method of claim 10, further comprising receiving a no-bust line selection via the user interface.

12. The method of claim 1, further comprising receiving a split rule selection via the user interface.

13. The method of claim 1, further comprising receiving a soft stay value selection via the user interface.

14. The method of claim 1, further comprising receiving a player stay value via the user interface.

15. The method of claim 1, further comprising displaying a card count associated with cards previously provided in the first array of card images or the second array of card images.

16. The method of claim 1, further comprising receiving a wager amount via the user interface.

17. The method of claim 1, further comprising receiving a number of runs via the user interface.

18. A method of entertaining a user, the method comprising:
assigning a card selected from a set of cards to each player position within a player card array, the player card array including at least three positions in a first dimension and at least two positions in a second dimension;
determining a run value of a run including a first position of the first dimension with at least two cards adjacent in the first dimension and in different positions in the second dimension of the player card array, the run value based on a sum of values of the at least two cards, the number of cards in the sum selected so that the sum exceeds a player stay value;
assigning a card selected from the set of cards to each dealer position within a dealer card array, the dealer card array including at least three positions in the first dimension and a single position in the second dimension;
determining a dealer value based on a sum of values of at least two cards, the number of cards in the sum selected so that the sum exceeds a dealer stay value;
comparing the run value with the dealer value; and
assigning a credit based on the comparing.

19. The method of claim 18, wherein the set of cards is a deck of cards.

20. The method of claim 18, wherein the card assigned to the each player position within the player card array is selected based on a card distribution.

21. The method of claim 18, further comprising determining a second run value of a second run including a card in the first position of the first dimension and at least two cards adjacent in the first dimension and in the same position along the second dimension.

22. The method of claim 18, further comprising determining a second run value of a second run including a card in the first position of the first dimension and at least three cards in different positions in the second dimension.

23. The method of claim 18, wherein the run includes cards from all positions within the first dimension.

24. The method of claim 23, further comprising assigning a win to the run independent of the dealer value when the run value does not exceed a bust value.

25. The method of claim 18, further comprising assigning an award based on pattern within a run independent of the run value.

26. The method of claim 25, wherein the award includes additional game play, credit points, non-credit points, a secondary game, a video sequence, or any combination thereof.

27. The method of claim 18, further comprising changing the run value to a previous value when the run value exceeds a bust value.

28. The method of claim 27, further comprising receiving a no-bust line selection from the user.

29. The method of claim 18, further comprising receiving a split rule selection from the user.

30. The method of claim 18, further comprising receiving a soft stay value selection from the user.

31. The method of claim 18, further comprising receiving a player stay value from the user.

32. The method of claim 18, wherein assigning credit includes assigning credit based on pay-out schedule.

33. The method of claim 18, further comprising displaying a card count associated with cards previously provided in the player card array or the dealer hand.

34. The method of claim 18, further comprising receiving a wager amount from the user.

35. The method of claim 18, further comprising receiving a number of runs from the user.

36. The method of claim 18, wherein the set of cards includes a wild card.

37. The method of claim 36, wherein the wild card has a value sufficient to yield a run value of blackjack.

38. The method of claim 36, further comprising awarding a player hand that includes a set of wild cards.

39. A system comprising:
a user interface;
a display device; and
a computational circuitry in communication with the user interface and the display device, the computational circuitry to implement a method comprising:
receiving a user action via the user interface;
in response to receiving the user action, displaying on the display device a first array of card images including at least three positions in a first dimension and a single position in a second dimension;
displaying on the display device a second array of card images including at least two positions in the first dimension and at least one position in the second dimension;
determining a set of values based on one or more runs including card images from the first array of card images, at least one run of the one or more runs including a first position of the first dimension with at least two card images adjacent in the first dimension and in different positions in the second dimension;
determining a second array value associated with the second array;
comparing each value of the set of values with the second array value; and
assigning credits to an account based on the comparing.

40. The system of claim 39, further comprising a network interface in communication with the computational circuitry, the computational circuitry to communication with a remote server via the network interface.
